(19) United States
(12) Patent Application Publication
(10) Pub. No.: US 2026/0008726 A1
(43) Pub. Date: Jan. 8, 2026

(54) PROCESS FOR MANUFACTURING PART MADE OF A COMPOSITE MATERIAL HAVING A CERAMIC MATRIX

(71) Applicants: SAFRAN CERAMICS, LE HAILLAN (FR); CENTRE NATIONAL DE LA RECHERCHE SCIENTIFIQUE, PARIS (FR); UNIVERSITE DE BORDEAUX, BORDEAUX (FR)

(72) Inventors: Eric BOUILLON, MOISSY-CRAMAYEL (FR); Hervé PLAISANTIN, MOISSY-CRAMAYEL (FR); Nathalie Dominique BERTRAND, SAINT-MAIXANT (FR); Amine EL MANSOURI, BORDEAUX (FR); Alain Jean-Michel GUETTE, LE BOUSCAT (FR)

(21) Appl. No.: 19/122,666

(22) PCT Filed: Oct. 17, 2023
(86) PCT No.: PCT/FR2023/051614

§ 371 Date: Apr. 18, 2025

(30) Foreign Application Priority Data
Oct. 21, 2022 (FR) FR2210904

(51) Int. Cl. C04B 35/573; C04B 35/63; C04B 35/80

(52) U.S. Cl. CPC C04B 35/573; C04B 35/6316; C04B 35/80; C04B 2235/3821; C04B 2235/3826; C04B 2235/386; C04B 2235/428; C04B 2235/5244; C04B 2235/5256; C04B 2235/616; C04B 2235/80

(57) ABSTRACT

A process for manufacturing a part made of ceramic matrix composite material, the process including infiltrating a pre-densified fibrous structure including a powder composition with a molten infiltration composition including silicon to form a ceramic matrix in a residual porosity of the pre-densified fibrous structure, the pre-densified fibrous structure including a pre-densification matrix including silicon carbide, and the powder composition including core-shell particles having a silicon carbide core and a shell having at least one layer of carbon or boron-doped carbon containing boron at an atomic proportion of 5% to 20%.

### TECHNICAL FIELD

The invention relates to the manufacture of a part made of ceramic matrix composite material (CMC) wherein the ceramic matrix is formed by infiltration of a silicon-based composition in the molten state (“Melt-Infiltration” (MI)). The invention proposes the presence of a functionalised powder composition to protect the pre-densification silicon carbide from attack by the molten silicon. The composite material part obtained in this way can be used as a part of the hot portion of a turbomachine, in particular an aeronautical turbomachine, such as a turbine part.

### PRIOR ART

Ceramic matrix composite materials can withstand temperatures ranging from 600° C. to 1400° C. Due to their greater resistance to high temperatures, CMCs require less cooling. Since this cooling traditionally comes from a compressor bleed, which has an impact on the efficiency of the turbomachine, CMC materials can therefore improve engine efficiency, which in turn reduces fuel consumption. Furthermore, their use helps to optimise the performance of turbomachines, in particular by reducing the overall weight of the turbomachine, which in turn contributes to a reduction in fuel consumption and therefore to a significant reduction in polluting emissions.

CMC parts can be formed by melt infiltration. In this technique, a molten silicon composition can be introduced into the pores of a fibrous structure that is pre-densified by a silicon carbide deposit and filled with silicon carbide particles. This method produces a fully dense Si—SiC matrix with high modulus and a composite with a high linearity limit. The composites obtained have good mechanical properties, but the inventors have observed a certain variability in elongation at break, which reduces the damage tolerance zone of the material. It is desirable to propose a solution to overcome this disadvantage.

### DISCLOSURE OF THE INVENTION

The invention relates to a process for manufacturing a part made of ceramic matrix composite material, said process comprising:
infiltrating a pre-densified fibrous structure comprising a powder composition with a molten infiltration composition comprising silicon, in order to form a ceramic matrix in a residual porosity of the pre-densified fibrous structure, the pre-densified fibrous structure comprising a pre-densification matrix comprising silicon carbide, and the powder composition comprising core-shell particles having a silicon carbide core and a shell having at least one layer of carbon or boron-doped carbon containing boron at an atomic proportion of 5% to 20%.

The inventors found that the variability in break behaviour was linked to an uncontrolled attack on the silicon carbide in the pre-densification matrix by the molten silicon in the prior art solution. This phenomenon can lead to degradation of the fibre reinforcement and of the interphase, resulting in a reduction in the structural character of the composite. The invention addresses this disadvantage by proposing a functionalisation of the powder composition using core-shell particles as described above, which can reduce the attack on the silicon carbide of the pre-densification matrix. The powder composition is distributed homogeneously throughout the pre-densified fibre structure in order to provide protection throughout its volume and throughout the infiltration. Composite materials with much improved break behaviour are thus obtained.

In an exemplary embodiment, the process further comprises the manufacturing of core-shell particles, before the infiltration, by forming the shell around the core by fluidised bed chemical vapour deposition.

The conditions under which the shell is formed during chemical vapour deposition advantageously enable a de-oxidisation of the surface of the silicon carbide core by reducing the size of the crystallites without any significant growth, and will therefore lead to better wetting by the molten silicon without promoting attack on the pre-densification silicon carbide. Once the carbon has been consumed from the shell, capillary rise will not be hindered by non-wettability, due to the prior deoxidation of the silicon carbide cores.

In an exemplary embodiment, the particle shell comprises a layer of boron-doped carbon containing boron in an atomic proportion of between 5% and 20%.

This feature further protects the underlying silicon carbide and provides protection throughout the volume of the pre-densified structure and throughout the infiltration, which further improves the behaviour at break of the resulting composite material. In particular, the shell of the particles may comprise a first layer made of boron-doped carbon containing boron at an atomic proportion of between 5% and 20%, and a second layer made of carbon that can cover the first layer. However, it does not go beyond the scope of the invention when the shell is single-layered with a layer of carbon or boron-doped carbon containing boron in an atomic proportion of between 5% and 20%.

In an exemplary embodiment, the infiltration composition comprises boron.

Such a feature can advantageously further protect the underlying silicon carbide.

In an exemplary embodiment, the shell of the particles can have a thickness between 5 nm and 300 nm, for example between 100 nm and 150 nm.

Such a feature enables a good compromise to be obtained between effective protection of the pre-densification silicon carbide during infiltration, without penalising the size of the particles, so as not to affect their ability to be introduced into the porosity of the fibrous structure.

In an exemplary embodiment, the pre-densified fibrous structure further comprises an interphase of boron nitride between a fibrous reinforcement and the pre-densification matrix.

The presence of a boron nitride interphase advantageously deflects any cracks that may appear in the matrix of the composite part during operation, so as to preserve the fibre reinforcement.

In an exemplary embodiment, the fibrous structure comprises a fibrous reinforcement formed by three-dimensional weaving or from a plurality of two-dimensional fibrous strata.

In one exemplary embodiment, the part is a turbomachine part.

The part may be a turbine part, for example an aircraft engine turbine part. The part may, for example, be a turbomachine blade, a turbine ring sector or a nozzle.

### BRIEF DESCRIPTION OF THE DRAWINGS

FIG. 1 is a flow diagram showing a succession of steps in an example of a process according to the invention.

FIG. 2 shows, schematically and in part, a core-shell particle that can be used in the context of the invention.

FIG. 3 shows transmission electron microscopy images of the particles before and after shell formation.

FIG. 4 shows, schematically and in part, a variant of a core-shell particle that can be used in the context of the invention.

### DESCRIPTION OF THE EMBODIMENTS

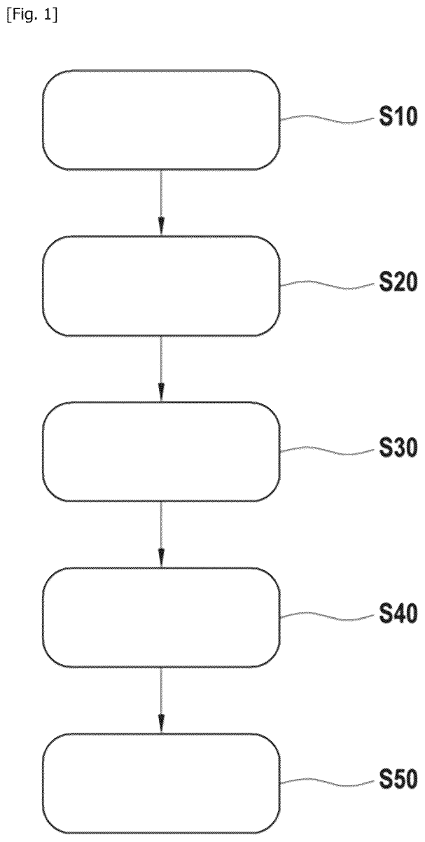

An example of a process for manufacturing a CMC material part according to the invention will now be described in conjunction with the flow diagram of FIG. 1.

A first step S10 of the process may involve forming the fibrous structure by implementing one or more textile operations, such as three-dimensional weaving. The fibrous structure may be formed from ceramic yarns, for example silicon carbide yarns. The fibrous structure can form the fibrous reinforcement of the composite material part to be obtained. Examples of silicon carbide yarns include “Nicalon”, “Hi-Nicalon”, “Hi-Nicalon-S” or Tyranno SA3 yarns from UBE Industries. The ceramic yarns in the fibrous structure may have an oxygen content of 1% or less by atomic percentage. “Hi-Nicalon-S” yarns, for example, have such a property. The term “three-dimensional weaving” or “3D weaving” should be understood as meaning a method of weaving by which at least some warp threads connect weft threads over a plurality of weft layers. A reversal of the roles between warp and weft is possible in the present description and should also be considered to be covered by the claims. The fibrous structure may have, for example, an interlock weave. The term “interlock weave or fabric”, should be understood to mean three-dimensional weaving, in which each layer of warp yarns connects a plurality of layers of weft yarns, with all the yarns of the same warp column having the same movement in the weave plane. It is also possible to start from fibrous textures such as two-dimensional fabrics or unidirectional sheets, and to obtain the fibrous structure by draping such fibrous textures on a form. These textures can optionally be bonded together, for example by stitching or implantation of yarns in order to form the fibrous structure.

In a step S20, an embrittlement-release interphase can be formed by chemical vapour infiltration on the yarns of the fibrous structure. The fibrous structure can be positioned in a shaping tooling enabling it to take the shape of the part to be obtained while the interphase is being deposited. The thickness of the interphase may be, for example, between 10 nm and 1000 nm, and for example between 200 nm and 500 nm. After formation of the interphase, the fibrous structure remains porous, the initially accessible porosity being filled only to a minority extent by the interphase. The interphase can be single-layered or multi-layered. The interphase may comprise at least one layer of pyrolytic carbon (PyC), boron nitride (BN), silicon-doped boron nitride (BN(Si), with the silicon having a proportion by mass of between 5% and 40%, the balance being boron nitride), or boron-doped carbon (BC, including boron in an atomic proportion between 5% and 20%, the balance being carbon). Here, the interphase has an embrittlement-release function for the composite material which promotes the diversion of possible cracks arriving at the interphase after having propagated in the matrix, preventing or delaying the breaking of the fibres by such cracks. Alternatively, it should be noted that it is possible to form the interphase on the yarns before the fibre structure is formed, i.e. before implementing step S10.

A step S30 is then carried out of forming a silicon carbide deposit. This step S30 can be separated into two phases. During the first phase, the fibrous structure is still in the shaping tool and a silicon carbide consolidation layer is deposited on the interphase and the fibre reinforcement. The consolidation layer can be deposited in contact with the interphase. This layer has sufficient thickness to sufficiently bind the fibres so that the structure retains its shape without assistance from the holding tool. This layer protects the interphase from oxidation and may be formed by chemical vapour infiltration in a manner known per se, for example from a gas phase comprising methyltrichlorosilane (MTS) and hydrogen (H₂). The thickness of the consolidation layer may be greater than or equal to 0.1 nm, for example between 0.1 μm and 5 μm. During the second phase, the consolidated fibrous structure shaped to the part to be obtained can be removed from the tooling and the pre-densification matrix can be formed by depositing a layer of silicon carbide. This layer can be deposited in contact with the consolidation layer. The thickness of this layer may be greater than the thickness of the consolidation layer. This layer of silicon carbide makes a large contribution to the mechanical performance of the composite material and provides protection from the molten silicon used during subsequent infiltration. The thickness of this layer may be greater than or equal to 1 μm, for example between 1 μm and 20 μm. As with the consolidation layer, the pre-densification matrix layer can be formed by chemical vapour infiltration in a manner known per se. According to a variant not illustrated, the consolidation layer could be omitted and the pre-densification matrix could be formed directly on the interphase. The residual porosity by volume of the pre-densified fibre structure obtained following step S30 may be between 20% and 40%, for example between 30% and 35%.

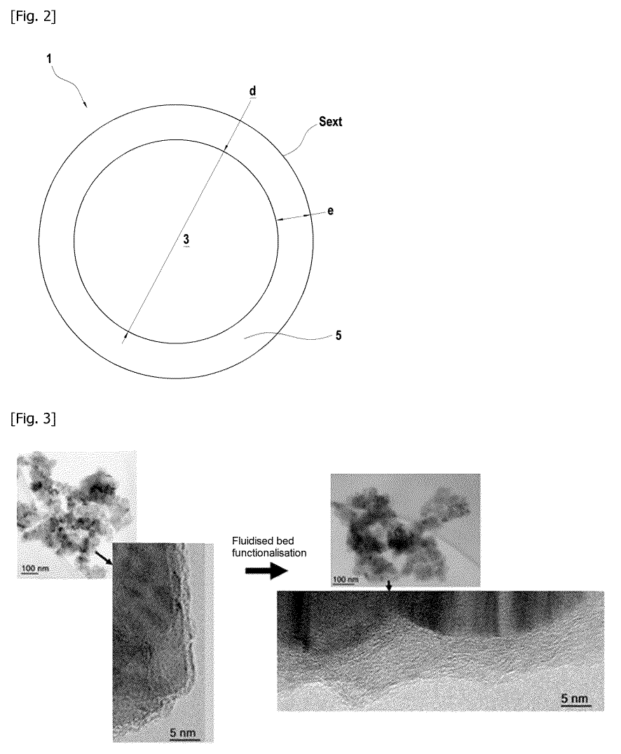

The process continues by introducing a powder composition into a residual porosity of the pre-densified structure (step S40). This powder composition can be introduced into the fibrous structure by the slurry-cast method, in a manner known per se. The powder composition is characterised in that it comprises core-shell particles 1, which will now be described. The particle 1 comprises a core 3 of silicon carbide and a shell formed by a layer 5, distinct from the core 3, which surrounds the latter. The shell 5 is made of carbon, or boron-doped carbon containing boron in an atomic proportion of between 5% and 20%. The shell 5 defines and outer surface Sext of the particle 1. Here the shell 5 is single-layered. In the illustrated example, the shell 5 extends from the surface Sext to the core 3. The shell 5 completely encapsulates the core 3. The particle 1 may be less than or equal to μm in size, for example less than or equal to 1 μm. The size d of the core 3 of the particles 1 may be between 0.5 μm and 4 μm. The thickness of the shell 5 may be between 5 nm and 300 nm, and for example between 100 nm and 150 nm. The particle 1 may have be in the form of a grain, having for example a substantially spherical or ellipsoidal shape. FIG. 2 illustrates the case of a two-material particle 1, where the particle 1 consists essentially of a core 3 made of silicon carbide and a region 5, in contact with the core 3, made of carbon or boron-doped carbon. As mentioned above, the particle 1 can be obtained by forming the shell 5 on the core 3 by fluidised bed chemical vapour deposition. The inventors have implemented the operating conditions below to manufacture such particles 1, which are given by way of example.

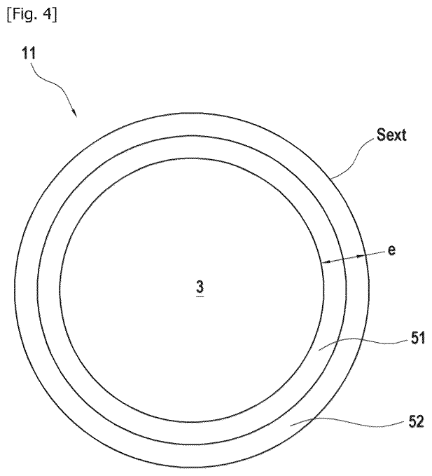

A 250 gram batch of silicon carbide powder was fluidised at 400 mbar with a nitrogen flow rate of 1000 standard cubic centimetres per minute (“sccm”). The fluidised bed was heated to 1000°° C. and then exposed to a propane flow of 200 standard cubic centimetres per minute for 5 hours. High Resolution TEM analysis (see FIG. 3) shows that the powder grains are initially coated with a thin amorphous nanometric layer, presumably of silica. After the treatment described above, the SiC grains are individually covered with a fine deposit of sp2 carbon. The carbon is in direct contact with the SiC surface and the amorphous layer has disappeared.

The residual porosity by volume of the pre-densified fibrous structure filled with the powder composition may be less than or equal to 25%, for example between 15% and 25%.

FIG. 2 illustrates a particle 11 with a single-layer 5 shell, but alternatively a particle with a two-layer shell can be used, comprising for example a first layer 51 made of boron-doped carbon which surrounds the core 3 and a second layer 52 made of carbon which surrounds the first layer, as illustrated in FIG. 4.

Once the powder composition has been introduced, step S50 is carried out, during which the residual pores are infiltrated with an infiltration composition in the molten state comprising at least silicon, so as to form a ceramic matrix in the porosity of the fibrous structure. The formation of this ceramic matrix can be used to finalise the densification of the part. This infiltration step corresponds to an infiltration step in the molten state. The infiltration composition can consist of pure molten silicon or, alternatively, can be in the form of a molten alloy of silicon and one or more other constituents. The infiltration composition may comprise a majority by mass of silicon, i.e. have a silicon content by mass greater than or equal to 50%. The infiltration composition may, for example, have a silicon content by mass greater than or equal to 75%. The one or more constituents present in the silicon alloy may be chosen from B, Al, Mo, Ti, Ge and the mixtures thereof. When the powder composition comprises carbon particles in addition to the core-shell particles, a chemical reaction can occur between the infiltration composition and these carbon particles during infiltration, resulting in the formation of silicon carbide. A reaction also occurs with the carbon of the shell.

After step S50, a part made of CMC material is obtained. Such a part made of CMC material may be a static or rotating turbomachine part. Examples of turbomachine parts have been mentioned above. Such a part may also be coated with an environmental or thermal barrier coating prior to use.

The expression “between . . . and . . . ” should be understood as including the limits.

1. A process for manufacturing a ceramic matrix composite part, comprising:
infiltrating a pre-densified fibrous structure comprising a powder composition with a molten infiltration composition comprising silicon, in order to form a ceramic matrix in a residual porosity of the pre-densified fibrous structure, the pre-densified fibrous structure comprising a pre-densification matrix comprising silicon carbide, and the powder composition comprising core-shell particles having a silicon carbide core and a shell having at least one layer of boron-doped carbon containing boron at an atomic proportion of between 5% and 20%.

2. The process according to claim 1, wherein the process further comprises the manufacturing of core-shell particles, before the infiltration, by forming the shell around the core by fluidised bed chemical vapour deposition.

3. The process according to claim 1, wherein the shell of the particles comprises a first layer made of boron-doped carbon containing boron at an atomic proportion of between 5% and 20%, and a second layer made of carbon covering the first layer.

4. The process according to claim 1, wherein the infiltration composition comprises boron.

51. The process according to claim 1, wherein the shell of the particles has a thickness of between 5 nm and 300 nm.

6. The process according to claim 1, wherein the pre-densified fibrous structure further comprises an interphase of boron nitride between a fibrous reinforcement and the pre-densification matrix.

7. The process according to claim 1, wherein the fibrous structure comprises a fibrous reinforcement formed by three-dimensional weaving or from a plurality of two-dimensional fibrous strata.

8. The process according to claim 1, wherein the part is a turbomachine part.
